(19) United States
(12) Patent Application Publication
(10) Pub. No.: US 2013/0277949 A1
(43) Pub. Date: Oct. 24, 2013

(54) SEAT ADJUSTMENT MECHANISM FOR A STROLLER

(71) Applicant: LERADO (ZHONG SHAN) INDUSTRIAL CO., LTD, Zhong Shan City (CN)

(72) Inventors: Tong-Jun YIN, Zhong Shan City (CN); Kuang-Neng CHENG, Dalin Town (TW)

(73) Assignee: Lerado (Zhong Shan) Industrial Co., Ltd, Zhong Shan City (CN)

(21) Appl. No.: 13/867,642

(22) Filed: Apr. 22, 2013

(30) Foreign Application Priority Data
Apr. 20, 2012 (CN) 201220173018.8

(51) Int. Cl. B60N 2/16

(52) U.S. Cl. CPC B60N 2/1685
USPC 280/658; 297/344.12

(57) ABSTRACT

A seat adjustment mechanism for a stroller, basically include a stroller frame having a first rail strut and a second rail strut extending upward and rearward, and a seat slidably engaged with the first rail strut and the second rail strut and capable of positioning along the first rail strut and the second rail strut at a selected height. Further, a positioning mechanism is operatively mounted between the stroller frame and the seat for locking the seat at the selected height, and a one-hand release mechanism is operatively mounted on the seat for release of the seat from the selected height. The seat can he lowered to a height that a little child can sit into by herself, and lifted by an adult care-giver to a selected height for either traveling around to use as a stroller or to use as a high chair for feeding the little child.

### BACKGROUND OF THE INVENTION

1. Field of the Invention

The present invention relates to a seat adjustment mechanism for a stroller, especially to a mechanism capable of changing the height of the stroller seat and converting the stroller to use as a high chair when need to feed or dining with an occupant of the stroller.

2. Description of the Related Art

Strollers are basic simple transport means for parenting babies and children. The seat of a traditional stroller is normally needed the adult care-givers to bend down themselves for holding up a baby occupant, this would possible hurt the knee and lumbar spine accidently.

When the baby occupants have grown up, sometime they may try to climb up the stroller seat by themselves; however the seat may be too high to a little child, which may cause the little child falling down during trying to climb up the stroller.

Further, the seats of traditional stroller are always too low to feed little child or use as a high chair for dining with family. It is a long need to adjust the stroller seat to be lower for little child to climb up more easily, and adjust the seat to be higher for use as a high chair.

A stroller with a height adjustable seat has been disclosed in Chinese Patent Application No. CN201120002470.3, however the structure of said seat is complex, which needs to manipulate with both hands to reposition the seat.

### SUMMARY OF THE INVENTION

In order to fulfill the above mentioned long need for converting a stroller to a high chair when feeding or dining with little child, the present invention provides a seat adjustment mechanism for a stroller, basically include a stroller frame having a first rail strut and a second rail strut extending upward and rearward, and a seat slidably engaged with the first rail strut and the second rail strut and capable of positioning along the first rail strut and the second rail strut at a selected height.

Further, a positioning mechanism may be operatively mounted between the stroller frame and the seat for locking the seat at the selected height, and a one-hand release mechanism is operatively mounted on the seat for release of the seat from the selected height.

By the seat adjustment mechanism according to the present invention, the seat can be lowered to a height that a little child can sit into by herself, and lifted by an adult care-giver to a selected height for either traveling around to use as a stroller or to use as a high chair for feeding the little child.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings;

FIG. 1 is a front-left perspective view showing an embodiment of the seat adjustment mechanism using with an erected stroller frame according to the present invention.

FIG. 2 is a front-left perspective view showing the stroller frame used in the embodiment is formed with a plurality of spaced apart holes for positioning the seat.

FIG. 3 is an exploded perspective view showing a positioning mechanism to be mounted on a body frame of the seat.

FIG. 4 is a cross-sectional view showing a one-hand release mechanism mounted in the body frame of the seat.

FIG. 5 is a schematic cross-sectional view showing the positioning mechanism is mounted on the seat and capable of locking the seat to a rail strut at a selected height.

FIG. 6 is a schematic cross-sectional view showing the positioning mechanism has been unlocked the seat from the rail strut by pulling an associating element.

FIG. 7. Is a schematic side view showing the seat is adjustable to a variety of heights, and can be lowered to permit a child to sit in without others aid, and then lifted by an adult care-giver to a selected height for either traveling around or use as a high chair for feeding or dining.

### DETAILED DESCRIPTION OF THE PREFERRED EMBODIMENTS

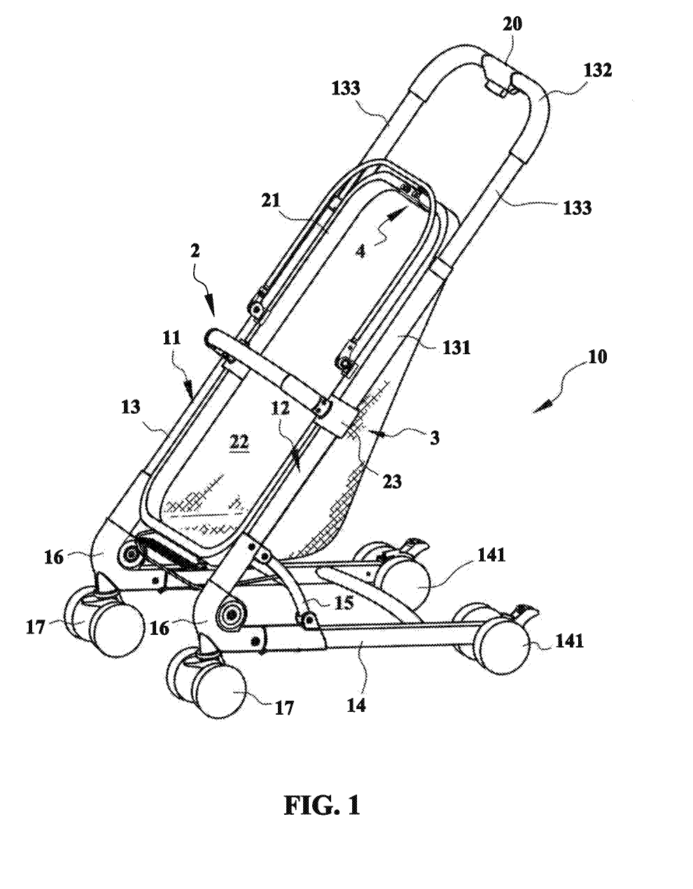

Referring to FIG. 1, an embodiment of the seat adjustment mechanism for a stroller according to the present invention includes a stroller frame 10, a seat 2, a positioning mechanism 3 and a one-hand release mechanism 4.

The stroller frame 10 is convertible between an erected position and a folded position (not shown), and has at least a first rail strut 11 and a second rail strut 12 both parallel to each other and extending upward and rearward.

In this embodiment, the stroller frame 10 includes a front rack 13, a base rack 14 and a pair of pivot joints 16. The front rack 13 is integrally connected with the first rail strut 11 and the second rail strut 12; the base rack 14 is wheeled with a pair of front wheels 17 and a pair of rear wheels 141; and the pair of pivot joints 16 is lockably pivoted the front rack 13 and the base rack 14 for permitting the front rack 13 to rotate relative to the base rack 14 so as to manipulate the stroller frame 10 to be rotated and locked in the erected position and folded into a folded position.

The stroller frame 10 may further include a pair of push arms 133 retractably and lockably connected with an upper ends 131 of the first rail strut 11 and the second rail strut 12. The pair of push arms 133 may also connect with a handle portion 132 on which a release actuator 20 is operatively mounted for associating with the pivot joints 16 thereby operating the release actuator 20 to unlock the stroller frame 10 from the erected position.

For more safety, the stroller frame 10 may further include a pair of linking rods 15 for firmly locking the stroller frame 10 in the erected position. For instance, each of the linking rods 15 may have an upper end pivoted on the front rack 13, and a lower end pivoted on a pair of sliders. The sliders are slidably mounted on the base rack 14, and can be locked to lock the stroller frame 10 in the erected position.

Referring to FIG. 1, the seat 2 has a body frame 21 and formed with a space 22 for accommodating an occupant. The body frame 21 is featured with capable of sliding along the first rail strut 11 and the second rail strut 12 so as to adjust to a height relative to ground. For instance, the body frame 21 may include a pair of sliding mounts 23 for slidably engaging with the first rail strut 11 and the second rail strut 12.

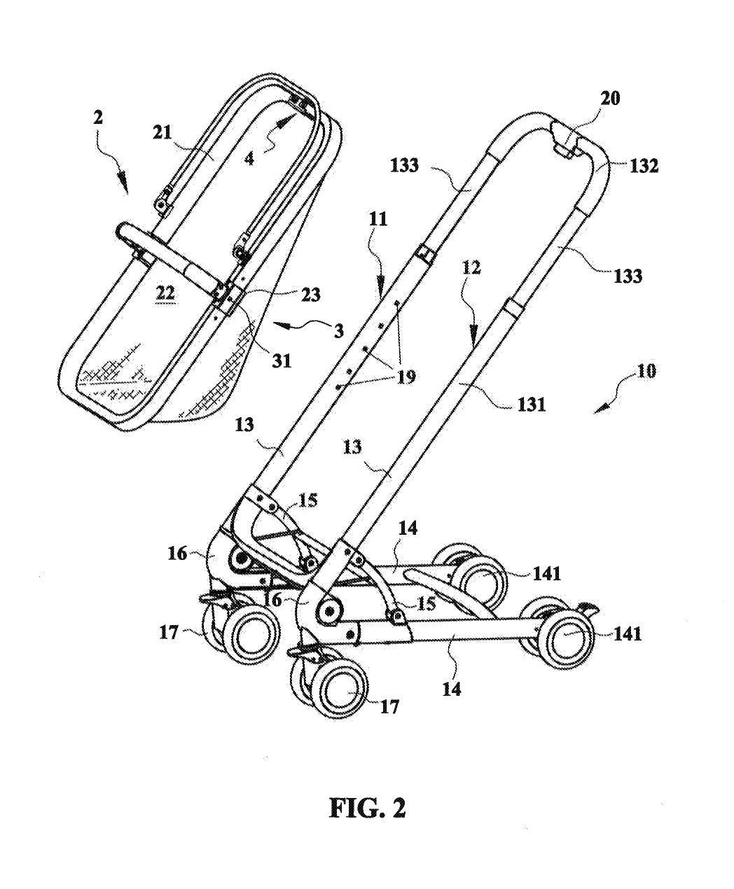

As shown in FIG. 2, the first rail strut 11 and the second rail strut 12 both are formed with a plurality of spaced apart holes 19 for engaging with the sliding mounts 23 to position the seat 2 in a variety of heights.

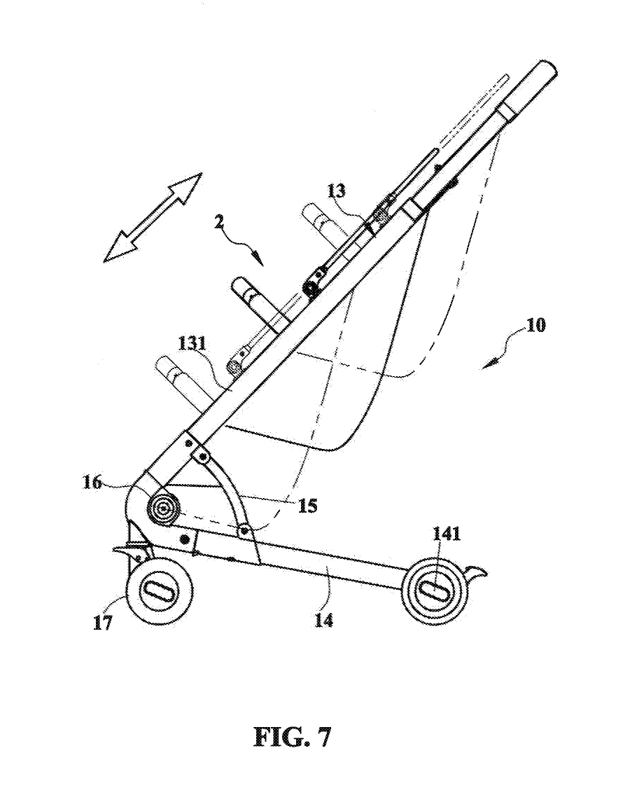

Referring to FIGS. 2 and 7, the seat 2 is slidably engaged with the first rail strut 11 and the second rail strut 12 and capable of positioning along the first rail strut 11 and the second rail strut 12 at a selected height.

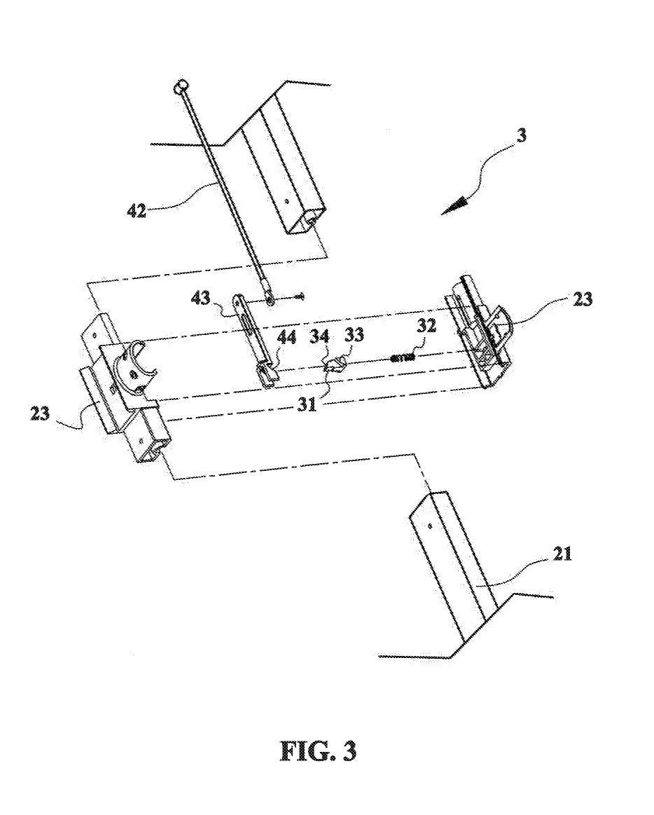

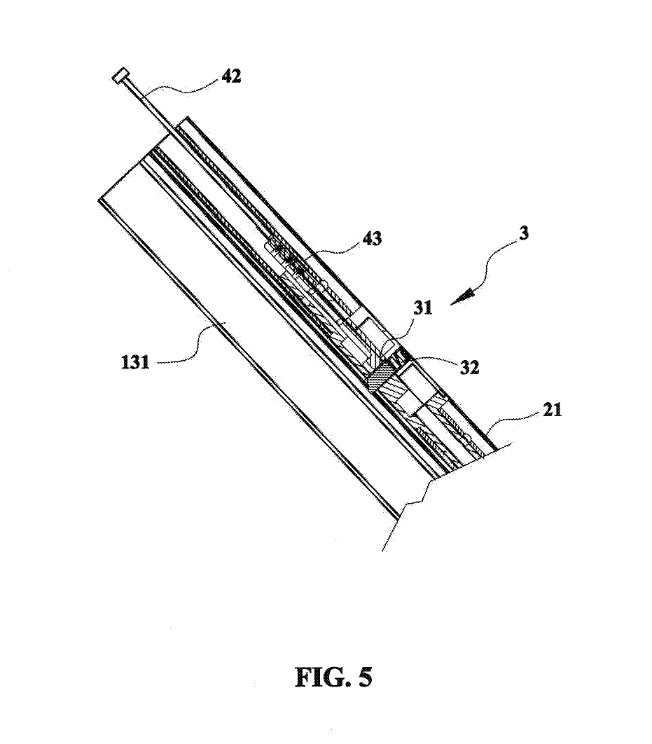

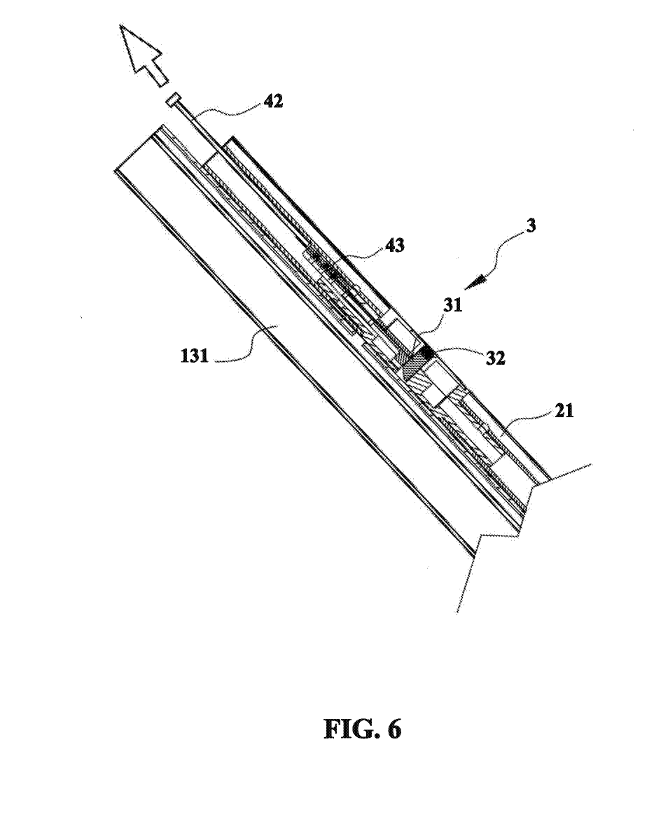

Referring to FIGS. 3, 5 and 6, the positioning mechanism 3 is operatively mounted between the stroller frame 10 and the seat 2 for locking the seat 2 at the selected height. Preferably, the seat 2 may be equipped with a pair of locking elements 31 each biased by a resilient element 32 for locking body frame 21 to the first rail strut 11 and the second rail strut 12 at the selected height. Preferably, the locking elements 31 are mounted inside the pair of sliding mounts 23 and biased by the resilient element 32 for engaging with one of the spaced apart holes 19 to lock the body frame 21 to the first rail strut 11 and the second rail strut 12 at the selected height.

Referring to FIG. 3, each of the locking elements 31 is featured with having one end formed with a slant face 34 facing frontward and upward; when the seat 2 is lifted to move upward, the spaced apart holes 19 may push the pair of locking elements 31 through the slant face 34 to retract and disengaged from the spaced apart holes 19.

Preferably, each of the locking elements 31 is featured with having one end formed with a slant face 34 facing frontward and upward; when the seat 2 is lifted to move upward without manipulating the remote actuator 41, the spaced apart holes 19 may push slant face 34 to retract and disengaged the pair of locking elements 31 from the spaced apart holes 19.

In this embodiment, the locking elements 31 are associated with the one-hand release mechanism 4 for unlocking the locking elements 31 from the first rail strut 11 and the second rail strut 12 so as to release of the seat 2 from the selected height.

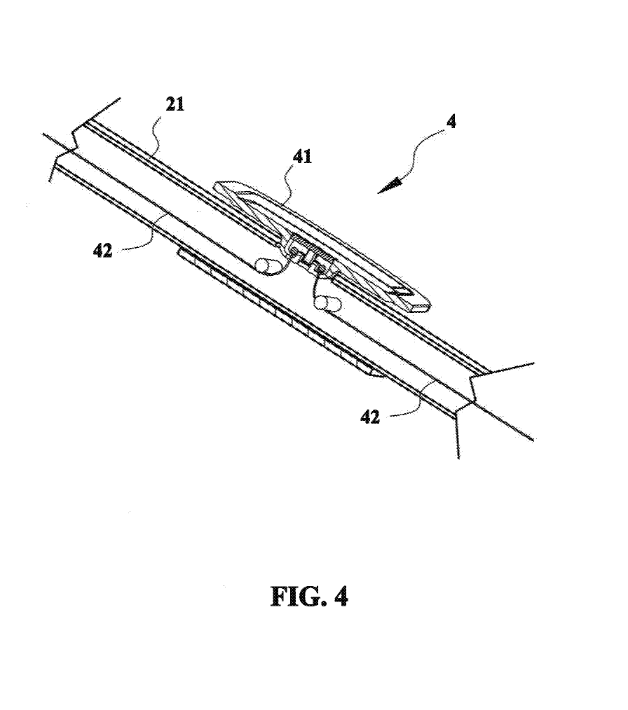

Referring to FIG. 4, the one-hand release mechanism 4 is operatively mounted on the seat 2 for release of the seat 2 from the selected height. The one-hand release mechanism 4 of this embodiment includes a remote actuator 41, a pair of driving elements 43, and a pair of associating elements 42.

The remote actuator 41 may either operatively mounted on a top of the seat 2 or mounted on beneath the seat 2, each being formed with a driving slant face 44 for slidably abutting against a driven slant face 33 formed on each of the locking elements 31 respectively.

The pair of associating elements 42 are connected between the emote actuator 41 and the driving elements 43, and capable of driving the locking elements 31 by manipulating the remote actuator 41 so as to release of the seat 2 from the selected height.

By manipulating the one-hand release mechanism 4 to drive the positioning mechanism 3, the seat 2 can be lowered to a height to permit a little child to sit in, and thereafter be lifted to a selected height for either traveling around or use as a high chair for feeding.

Referring to FIG. 7, the seat can be lowered to permit a child to sit in without others aid, and then lifted by an adult care-giver so as to be positioned at a selected height for either traveling around or use as a high chair for feeding or dining together with others.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A seat adjustment mechanism for a stroller, includes:
a stroller frame convertible between an erected position and a folded position, having a first rail strut and a second rail strut both parallel to each other and extending upward and rearward;
a seat slidably engaged with the first rail strut and the second rail strut and capable of positioning along the first rail strut and the second rail strut at a selected height;
a positioning mechanism operatively mounted between the stroller frame and the seat for locking the seat at the selected height; and
a one-hand release mechanism operatively mounted on the seat for release of the seat from the selected height.

2. The seat adjustment mechanism for a stroller according to claim 1, wherein the stroller frame further include:
a front rack integrally connected with the first rail strut and the second rail strut;
a base rack wheeled with a pair of front wheels and a pair of rear wheels; and
a pair of pivot joints lockably pivoted the front rack and the base rack for permitting the front rack to rotate relative to the base rack so as to manipulate the stroller frame to be rotated and locked in the erected position and folded into the folded position.

3. The seat adjustment mechanism for a stroller according to claim 1, wherein the stroller frame further include:
a front rack integrally connected with the first rail strut and the second rail strut;
a base rack wheeled with a pair of front wheels and a pair of rear wheels;
a pair of pivot joints pivoted the front rack and the base rack for permitting the front rack to rotate relative to the base rack so as to manipulate the stroller frame to be rotated and locked in the erected position and folded into the folded position; and
a pair of linking rods having upper end pivoted on the front rack, and a lower end pivoted on a pair of sliders, wherein the sliders is slidably mounted on the base rack and can he locked against from sliding for locking the stroller frame in the erected position.

4. The seat adjustment mechanism for a stroller according to claim 1, wherein the seat has a body frame capable of sliding along the first rail strut and the second rail strut to adjust to a height relative to ground.

5. The seat adjustment mechanism for a stroller according to claim 4, wherein the body frame has a pair of sliding mounts for slidably engaging with the first rail strut and the second rail strut.

6. The seat adjustment mechanism for a stroller according to claim 1, wherein the first rail strut and the second rail strut both are formed with a plurality of spaced apart holes for position the seat in a variety of heights.

7. The seat adjustment mechanism for a stroller according to claim 4, wherein the seat is equipped with a pair of locking elements each biased by a resilient element for locking body frame to the first rail strut and the second rail strut at the selected height.

8. The seat adjustment mechanism for a stroller according to claim 5 further included a pair of locking elements each biased by a resilient element and operatively mounted on the body frame for locking the body frame to the first rail strut and the second rail strut at the selected height.

9. The seat adjustment mechanism for a stroller according to claim 6 further included a pair of locking elements each biased by a resilient element and operatively mounted inside the pair of sliding mounts for engaging with one of the spaced apart holes to lock the body frame to the first rail strut and the second rail strut at the selected height.

10. The seat adjustment mechanism for a stroller according to claim 7, wherein the first rail strut and the second rail strut both are formed with a plurality of spaced apart holes for position the seat in a variety of heights, and wherein each of the pair of locking elements is engageable with one of the spaced apart holes; each of the locking elements is featured with having one end formed with a slant face facing frontward and upward; when the seat is lifted to move upward, the spaced apart holes may push the pair of locking elements through the slant face to retract and disengaged from the spaced apart holes.

11. The seat adjustment mechanism for a stroller according to claim 7, wherein the pair of locking elements are engaged with the one-hand release mechanism for unlocking the locking elements from the first rail strut and the second rail strut so as to release of the seat from the selected height.

12. The seat adjustment mechanism for a stroller according to claim 11, wherein the one-hand release mechanism includes:
a remote actuator operatively mounted on the seat;
a pair of driving elements each being formed with a driving slant face slidably abutted against on a driven slant face formed on each of the locking elements respectively;
a pair of associating elements connected between the remote actuator and the driving elements;
wherein the pair of driving elements is capable of driving the locking elements by manipulating the remote actuator so as to release of the seat from the selected height.

13. The seat adjustment mechanism for a stroller according to claim 12, wherein the first rail strut and the second rail strut both are formed with a plurality of spaced apart holes for position the seat in a variety of heights, and wherein each of the pair of locking elements is engageable with one of the spaced apart holes; each of the locking elements is featured with having one end formed with a slant face facing frontward and upward; when the seat is lifted to move upward without manipulating the remote actuator, the spaced apart holes may push slant face to retract and disengaged the pair of locking elements from the spaced apart holes.

14. The seat adjustment mechanism for a stroller according to claim 12, wherein the remote actuator operatively mounted on a top of the seat.

15. The seat adjustment mechanism for a stroller according to claim 12, wherein the remote actuator operatively mounted beneath the seat.

16. The seat adjustment mechanism for a stroller according to claim 1, wherein the stroller frame further include a pair of push arms retractably and lockably connected with an upper ends of the first rail strut and the second rail strut.

17. The seat adjustment mechanism for a stroller according to claim 2, wherein the stroller frame further include a pair of push arms retractably and lockably connected with an upper ends of the first rail strut and the second rail strut, and wherein the pair of push arms are connected with a handle portion on which a release actuator is operatively mounted for associating with the pivot joints thereby operating the release actuator to unlock the stroller frame from the erected position.
